(19) United States
(12) Patent Application Publication
(10) Pub. No.: US 2011/0078903 A1
(43) Pub. Date: Apr. 7, 2011

(54) Method and arrangement for a spray coating process

(76) Inventors: Wolfgang Dorn, Berlin (DE); Francis-Jurjen Ladru, Berlin (DE)

(21) Appl. No.: 12/896,984

(22) Filed: Oct. 4, 2010

(30) Foreign Application Priority Data
Oct. 6, 2009 (EP) 09012638.4

(51) Int. Cl. B23P 15/02; B29D 99/00

(52) U.S. Cl. 29/889.71; 156/212

(57) ABSTRACT

A method for preparing a blade of a turbomachine for a spray coating process is provided. The method includes providing a sheet of flexible material which is shaped such that, when the sheet is bent circumferentially around a blade root of the blade along a longitudinal axis of the blade, the sheet forms a circumferential cover on the surface of the blade root, and bending the sheet around the blade root to form the cover. The sheet is positioned on the blade root up to a platform between an airfoil and the blade root. The sheet is placed on the blade root such that the sheet forms a circumferentially closed structure around the blade root. Further, an arrangement for a spray coating process is provided.

### CROSS REFERENCE TO RELATED APPLICATIONS

This application claims priority of European Patent Office Application No. 09012638.4 EP filed Oct. 6, 2009, which is incorporated by reference herein in its entirety.

### FIELD OF INVENTION

The present invention relates to a method and an arrangement for a spray coating process of a turbine blade.

### BACKGROUND OF INVENTION

A gas turbine engine includes one or more turbine blades extending radially outwardly from a rotatable hub. Each blade has a blade root that engages with a slot in the hub and an airfoil that extends radially across the working medium gas flow path. The turbine blade also includes a platform between the blade root and airfoil. During engine operation, turbine blade portions such as air foil come in direct contact with the working medium gas. The air foil is thus subjected to damages due to the elevated temperature of the gas during the engine operation.

Usually, a protective coating is applied on the airfoil section of the blade which is exposed to the working medium to improve their temperature resistance and/or abrasion resistance. The turbine blade is spray coated using conventional spraying techniques which can provide thick coatings over a large area at a high deposition rate. Examples of such spray coating methods include atmospheric plasma spraying (APS) high velocity oxygen fuel spraying (HVOF), wire arc spraying and others.

In the application of spray coating on turbine blades, areas that are not meant to be coated should be protected by constructional measures and processes that controls against overspray. Due to the spray spot size, spray material on mechanical finished surfaces is deposited. This spray material deposit is referred to as overspray. Therefore it is a common practice of using coating fixtures in conjunction with a spray coating application to facilitate covering to blade root that are to be protected from overspray.

US20070110910 discloses a mounting suitable for covering the overspray area of the turbine blade. The mounting device is a box-like structure defining an inner portion with an opening to receive the turbine blade. The turbine blade is inserted into the inner portion of the mounting device such that the root portion of the turbine blade is surrounded by the inner portion. A shielding layer is arranged between a rim of the inner portion and the portion of the blade region that adjoins the blade root such that the root region is completely shielded from overspray.

### SUMMARY OF INVENTION

An object of the invention is to provide an improved covering for a blade root of a turbine blade to be protected from overspray.

The object is achieved by a method and an arrangement according to the claims.

The invention is set forth and characterized in the independent claims, while the dependent claims describe other characteristics of the invention.

The underlying idea of the present invention is to provide a cover for protecting the blade root of a turbine blade from a spray deposit during a spray coating. The use of a sheet of flexible material to cover the blade root helps to place the sheet along the circumference of the blade root to provide an improved covering. The flexibility of the material makes it easy to shape the sheet in the faun of the blade root to tightly cover the blade root. This reduces the probability of leaving any gap between the blade root and the sheet, which in turn prevents the deposit of the spray on the blade root.

According to an embodiment herein, the sheet is positioned on the blade root such that the sheet is in contact with a platform between an airfoil and the blade root. This avoids any deposit of the coating spray on the surface area of the blade root where it adjoins the platform, where the chance of deposit is more likely to occur.

According to an embodiment herein, the sheet is placed on the blade root such that the sheet forms a circumferentially closed structure around the blade root. This provides the flexibility of spray coating the blade irrespective of any spray direction.

According to another embodiment herein, the method provides a connecting mechanism to interlock the sheet around the blade root. This prevents a displacement of the sheet from its position around the blade root.

According to another embodiment herein, an adhesive tape is placed on the blade root between the sheet and the airfoil. This helps to seal even a narrow space which is likely to occur between the blade root and the airfoil.

Another embodiment herein includes providing a box having an opening to receive the blade root with the sheet, wherein the opening is such that is closes a volume around blade root when the blade root is inserted into the box and inserting the blade root to the box such that the blade root is surrounded by the box. The size and configuration makes it easy to place the blade into the box and also provides for improved masking as the spray gets deposited on the box prior to the sheet, thereby reducing the amount of spray likely to be deposited on the sheet.

According to another preferred embodiment, the flexible material is a resilient material. The elasticity of the material exerts a tension which provides for a tight fit of the sheet on surface of the blade root.

According to another preferred embodiment, the flexible material is a metal. This material is easily available and is relatively inexpensive.

According to another preferred embodiment, the flexible material is a polymeric material. This material can easily be cleaned from spray and can be reused easily to reduce the costs.

According to another preferred embodiment, the flexible material has a low coefficient of thermal expansion. This prevents the loosening of the sheet because of the expansion caused by the heat, thereby providing a good protection against overspray even for coating processes taking place in a high temperature environment.

Another aspect of the invention depicts an arrangement for a spray coating process, the arrangement comprises a turbine blade comprising an airfoil, a blade root and a platform between the airfoil and the blade root and a sheet of flexible material which is shaped such that when it is bend circumferentially around a blade root of the blade along a longitudinal axis of the blade the sheet forms a circumferential cover on the surface of the blade root. The flexibility of the material makes it easy to shape the sheet in the form of the blade root to tightly cover the blade root. This reduces the probability of leaving any gap between the blade root and the sheet, which in turn prevents the deposit of the spray on the blade root.

### BRIEF DESCRIPTION OF THE DRAWINGS

The present invention is further described hereinafter with reference to illustrated embodiments shown in the accompanying drawings, in which:

FIG. 1 illustrates a perspective front view of a turbine blade with a sheet of flexible material installed on the blade root in accordance with the embodiment herein;

FIG. 2 shows a perspective rear view of the embodiment of FIG. 1;

FIG. 3 shows a schematic view of the sheet of flexible material;

FIG. 4 shows an alternate embodiment of preparing the turbine blade for a coating process; and

FIG. 5 shows a cross-sectional view of the embodiment of FIG. 4.

### DETAILED DESCRIPTION OF INVENTION

Various embodiments are described with reference to the drawings, wherein like reference numerals are used to refer to single elements throughout. In the following description, for purpose of explanation, numerous specific details are set forth in order to provide a thorough understanding of one or more embodiments. It may be evident that such embodiments may be practiced without these specific details.

The present invention thus provides a method of preparing a machine component for a spray coating process. The present invention may be used particularly, though not exclusively, for a blade of a turbomachine. Hence it should be appreciated that although the embodiments illustrated hereinafter refer particularly to a blade used in the turbine section of a turbine engine, the present invention is equally applicable for repair of other machine components also. Here, the turbomachine refers to any rotating machinery incorporating a turbine that adds or removes mechanical power from a continuous, steadily flowing stream of fluid.

A turbomachine operates through the action of rows of blades attached to a circular rotor which is mounted on a rotating shaft. Examples of turbomachines include certain kinds of compressors, as well as turbopumps, turbines, hydraulic transmission impellers and the like. The turbine blade usually comprises stationary vanes which are designed to receive, interact with and discharge the working medium gases as the gases are flowed through the engine. The turbine blades are attached to the disk by fitting in the blade root into a groove in the rotor disk, thereby locking the movement of the blade from any movement.

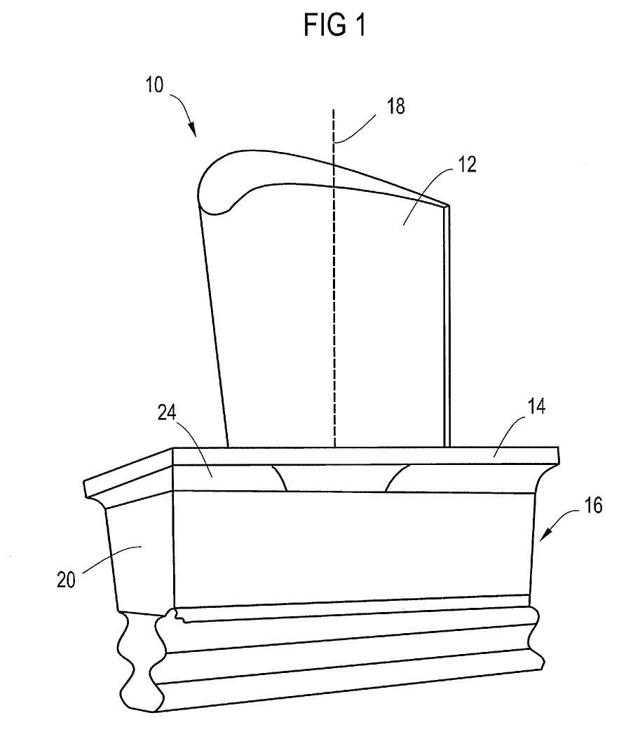

FIG. 1 illustrates a perspective front view of a turbine blade 10 with a sheet 20 of material installed on the blade root 16 in accordance with the embodiment herein. A turbine blade 10 comprises an airfoil 12, a blade root 16 and a platform 14 between the airfoil 12 and the blade root 16 which are constructed as a single piece, thereby being integral with each other. The blade root 16 is adapted to fit within one of the slots in the periphery of the rotor disk (not shown) with the airfoil 12 extending radially outwardly from the disk. The airfoil 12, blade root 16 and the platform 14 could also be separate parts which can be assembled together.

Referring to the FIG. 1 there is shown a sheet 20 of flexible material placed around the blade root 16. The sheet 20 of flexible material is provided in such a way that it is shaped to enclose the blade root 16 circumferentially along the longitudinal axis 18 of the turbine blade 10. The sheet 20 is bent along the periphery of the blade 10 to provide a shape that matches with the shape of the blade root 16.

The sheet 20 is placed on to cover the blade root 16 by force fitting the sheet 20 on to the surface of the blade root 16. The sheet 20 is generally placed on a portion of the blade root 16 where the chance of depositing the spray is expected to be more.

The sheet 20 is relatively a thin flat sheet of a resilient material which serves to function as a mechanical barrier between the coating spray and the blade root 16. The bending of the sheet 20 serves to increase the local stress and enables to fit firmly on the blade root 16.

The sheet 20 is arranged in such a way that it is positioned to adjoin with a region of the blade root 16 which intersects with the platform 14 between the airfoil 12 and blade root 16. As shown in FIG. 1, an adhesive tape 24 is placed between the platform 12 and the portion of the blade root 16 adjoining the airfoil 14. The adhesive tape 24 helps to seal any gap between the platform 14 and the portion of the sheet 20 adjoining the platform 14. This prevents the leakage of the spray through the gap onto the surface of the blade root 16.

The adhesive tape 24 is, for example, a hardenable plastic film applied to or flowed upon selected areas of the blade root 16. The use of such adhesive tapes 24 provides for substantial trimming of gap, especially about the periphery of the portion of the blade root 16 adjoining the airfoil 12.

The sheet 20 when placed on the blade root 16 forms a circumferentially closed structure around the blade root 16.

In the installed condition, the sheet 20 is spaced less than a predetermined distance from the blade root 16. The elasticity of the material abuts the sheet 20 and exerts a compressive force on the sheet 20. The compressive force resists any movement or prevents the release of sheet 20 from the surface of the blade root 16. This prevents the occurrence of any spacing between the blade root 16 and the sheet 20.

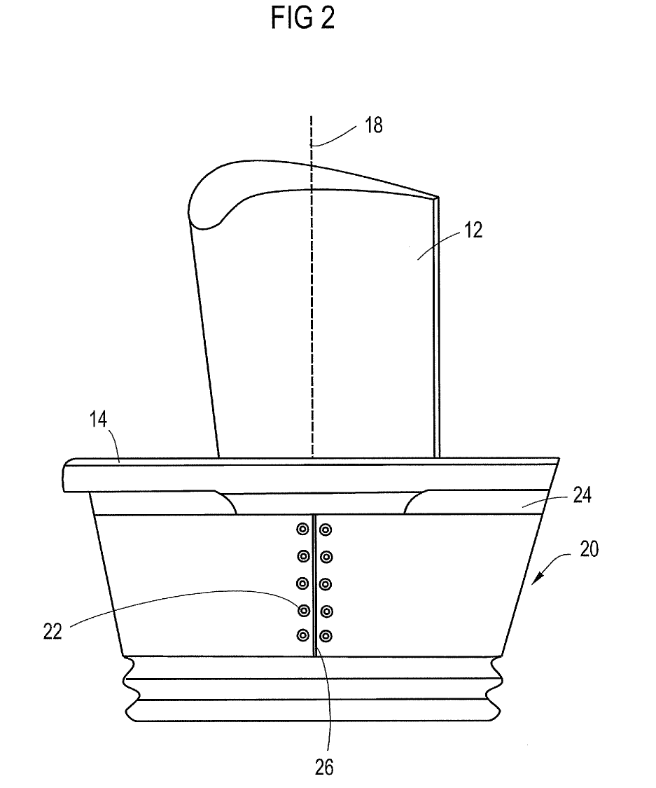

FIG. 2 shows a perspective rear view of the embodiment of FIG. 1. The FIG. 2 shows the portion of the turbine blade 10 where the sheet 20 abuts on the surface of the blade root 16. The sheet 20 is bent in such a way that the end sections 26 of the sheet 20 defined along the longitudinal axis 18 of the blade 10 adjoin substantially on one side of the blade root 16 to provide a relatively close and firm but releasable fit.

As shown in the figure, the sheet 20 is placed over a part of the outer surface of the blade root 16 to protect such parts which is more likely to be subjected to overspray during a coating process. When fully assembled, the sheet 10 encloses the blade root 16, exposing only the airfoil 12 of the blade 10 which is expected to the coated.

The end sections 26 can be provided with a connecting mechanism to interlock the sheet 20 around the blade root 16. The connecting mechanism herein is a hook 22 to fasten the sheet 20 onto the blade root 16. This interlocking provides a secure fitting and prevents the dislodgement of the sheet 20 from the blade root 16. The connecting mechanism can be also for example, elastic straps, nuts or any other structure which can support the sheet 20 in fixed relation to the blade root 16.

The end sections 26 of the sheet 20 can also be placed in such a manner that one end section overlaps with the other end section, thereby providing a completely closed structure without leaving any gap along the circumference of the blade root 16. The overlapping feature of the sheet 20 adds for securing the sheet on to the blade root 16 and also prevents the leakage of spray onto the blade root 16.

The sheet 20 can be of a single piece or of multiple elements, for example a first member carrying a mask surface and protrusion secured with a second or backing member. In that form, the first and second member together forms the masking member.

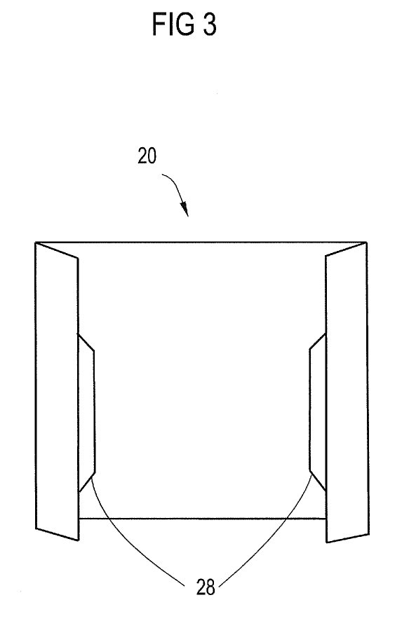

FIG. 3 shows a schematic view of the sheet 20 of flexible material of FIG. 1. The sheet 20 is preferably a thin flat plate of a resilient material which can be shaped to cover the surface of the blade root 16 to protect it from overspray mist during a spray coating process.

The sheet 20 includes two end sections 26, wherein when the sheet 20 is installed on the blade root 16, the end sections 26 extend along the length of the blade 10. The sheet 20 is shown provided with a connecting mechanism at the end sections 26 to secure the sheet 20 on to the blade root 16. The connecting mechanism shown herein is a flange 28 extending from the longitudinal end sections of the sheet 20 which serves to effectively lock the two end sections 26 so there is no relative movement of the sheet 20. The sheet 20 when locked by the connecting mechanism 28 creates a circumferentially closed structure on the blade root 16.

The sheet 20 of material is preferably made of a metal such as a stainless steel, nickel or metal alloys such as Nickelchrome or the similar. One suitable material is a stainless steel having a thickness of approximately 10000 mm-50000 mm. The sheet 20 of material can also be a polymeric material such as polypropylene, polyethylene or the like. These materials are of relatively less cost, and can be cleaned easily, thereby reducing the cost involved in cleaning the overspray deposit from the sheet for further usage.

Generally, these materials are inert to the spray, or other gases, dust or other abrasive particles, which helps to protect the blade root 16. The sheet 20 is easily and quickly installable and removable so that the likelihood of repetitive motion injuries is reduced and the pace of coating operations can be accelerated. The sheet 16 is inexpensive and has high durability which makes it possible to reuse the sheet 20 for a substantial number of times.

The sheet 20 is substantially of uniform thickness and can be unitized in association with many different types of objects other than blade roots. The sheet 20 can also be provided with various other locking mechanisms such as hinges, elastic straps, etc to firmly hold the sheet 20 around the blade root 16.

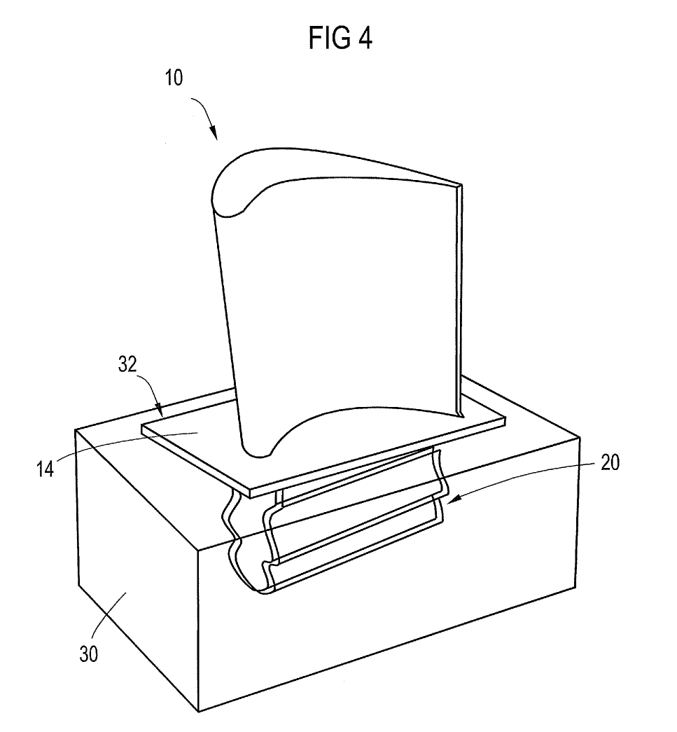

FIG. 4 shows an alternate embodiment of preparing the turbine blade 10 for a coating process. This embodiment includes a box 30 for the turbine component in addition to the sheet 20 of flexible material to prevent the deposit of spray on the surface of the blade root 16. The use of such box-like structures to cover the blade root 16 is known. However, it does not provide for sealing the blade root 16 completely. Therefore using both the box 30 and the sheet 20 provides a better protection against overspray than just using the box alone.

The box 30 has at least one opening 32 to receive the turbine root 16 to firmly position the turbine root 16 within the box 30. The turbine blade 10 is positioned in such a way that the box 30 encloses the blade root 16 and the airfoil 12 extends radially outwards through the opening 32.

The size of the opening 32 is selected such that the opening 32 is such that is closes a volume around blade root 16 when the blade root 16 is inserted into the box 30. This give a tight fitting of the blade root 16 within the box 30. The size can vary depending upon the turbine component undergoing the coating. Such boxes 30 are optional features providing additional protection to the blade root 16.

Here, the box 30 can be placed to surround the blade root 16 before the blade root 16 is covered with the sheet 20 so that the sheet 20 extends over the box 30 containing the blade root 16. The box 30 can also be placed after covering the blade root 16 with the sheet 20 such that the box 30 encloses both the blade root 16 and the sheet 20. Using the sheet 20 alone to cover the blade root 16 is not sufficient for improved covering and thus has to use the box 30 in addition. This saves time because the overspray need not be removed anymore as compared to just the box 30 and need not remove the overspray. The box 30 and the sheet 20 helps to completely cover the blade root 16 to provide a better protection against overspray deposit.

As described, the box 30 forms a barrier while also comprised of a material that is inert to coating materials. The box 30 can be made of a metallic or non-metallic material. For example, the box 30 may be partially or completely constructed of graphite or a ceramic material or the like.

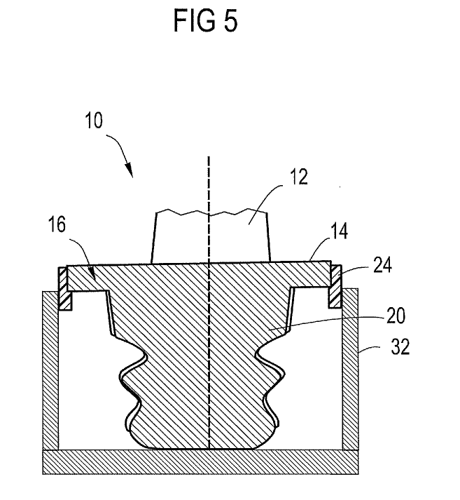

FIG. 5 illustrates a cross-sectional view of the embodiment shown in FIG. 4. The figure shows a cross sectional view of a turbine blade 10, wherein the blade root 16 is covered by a sheet of flexible material and is enclosed within a box 30.

The box 30 encloses a cavity into which the turbine blade 10 is inserted vertically from above in such a way that the blade root 16 is located substantially within the cavity and the turbine blade 10 extends with its airfoil 12 that is subjected to the medium flowing through during the operation of the turbine provided with it outside the box 30.

As shown in FIG. 5, the turbine blade 10 also includes a covering sheet 20 placed on its blade root 16. The sheet 20 is placed in such a manner that it forms a closed structure around the blade root 16. The elasticity of the material holds the sheet 20 tightly on the surface of the blade root 16, thereby preventing the formation of any gap between the blade root 16 and the sheet 20.

Here the diameter of the opening 32 of the box 30 is equal to the diameter of the blade root 16. This is taken is such a way that when the blade root 16 is inserted in the box 30, the sides of the blade root 16 adjoins with the opening. In this way, the distance between the blade root 16 and the inner side of the box 30 is bridged. This prevents the leakage of spray through the gap on to the sheet 20.

As shown in FIG. 5, an adhesive tape 24 is shown placed between the platform 12 and the blade root 16 to bridge a gap between the box 30 and the blade root 16. Here too, the adhesive tape 24 covers the blade root 16 up to its upper edge, thereby preventing the chances of spray deposit on the blade root 16.

The present invention provides an efficient, rapidly and easily applicable and removable masking arrangement which is reusable. The spray which is deposited on the sheet can be removed by using various processes such as using an aqueous effluent to rinse off the spray, treating with deactivation solutions or the any solvents, which cleans the surface of the sheet to be reused.

The blade root covering sheet provided herein is thus durable, replaceable, minimally affecting the existing turbine disc parameters. The sheet is adaptable to be installed on blade root without entailing large expenses in root alteration.

1.-15. (canceled)

16. A method of preparing a blade of a turbomachine for a spray coating process, comprising:
providing a sheet of flexible material, the sheet being shaped such that, when bending the sheet circumferentially around a blade root of the blade along a longitudinal axis of the blade, the sheet forms a circumferential cover on a surface of the blade root; and
bending the sheet around the blade root to form the circumferential cover.

17. The method according to claim 16, further comprising:
positioning the sheet on the blade root such that the sheet is in contact with a platform between an airfoil and the blade root.

18. The method according to claim 16, wherein the sheet is placed on the blade root such that the sheet forms a circumferentially closed structure around the blade root.

19. The method according to claim 16, further comprising:
providing a connecting mechanism for interlocking the sheet around the blade root.

20. The method according to claim 17, further comprising:
providing an adhesive tape placed on the blade root between the sheet and the airfoil.

21. The method according to claim 16, further comprising:
providing a box with an opening for receiving the blade root with the sheet; and
inserting the blade root into the box such that the blade root is surrounded by the box.

22. The method according to claim 16, wherein the flexible material is a resilient material.

23. The method according to claim 16, wherein the flexible material is a metal.

24. The method according to claim 16, wherein the flexible material is a polymeric material.

25. The method according to claim 16, wherein the flexible material has a low coefficient of thermal expansion.

26. An arrangement for a spray coating process, the arrangement comprising:
a turbine blade comprising an airfoil, a blade root and a platform between the airfoil and the blade root; and
a sheet of flexible material, the sheet being shaped such that, when bending the sheet circumferentially around a blade root of the blade along a longitudinal axis of the blade, the sheet forms a circumferential cover on the surface of the blade root.

27. The arrangement according to claim 26, wherein the sheet comprises a connecting mechanism for interlocking the sheet around the blade root.

28. The arrangement according to claim 27, wherein the connecting mechanism includes a strap and a hook.

29. The arrangement according to claim 26, further comprising:
an adhesive tape for sealing a gap between the airfoil and a portion of the sheet adjoining the airfoil.

30. The arrangement according to claim 26, further comprising:
a box with an opening for receiving the blade root with the sheet, wherein the blade root is surrounded by the box when the blade root is inserted into the box.

31. The arrangement according to claim 26, wherein the flexible material is a resilient material.

32. The arrangement according to claim 26, wherein the flexible material is a metal.

33. The arrangement according to claim 26, wherein the flexible material is a polymeric material.

34. The arrangement according to claim 26, wherein the flexible material has a low coefficient of thermal expansion.
